(19) United States
(12) Patent Application Publication
(10) Pub. No.: US 2017/0029210 A1
(43) Pub. Date: Feb. 2, 2017

(54) STORAGE DEVICE

(71) Applicant: JBG-2 Sp. zo. o., Warszowice (PL)

(72) Inventors: Adrian Brzozka, Ustron (PL); Lech Gold, Swietochlowice (PL)

(73) Assignee: JBG-2 Sp. zo. o., Warszowice (PL)

(21) Appl. No.: 15/224,315

(22) Filed: Jul. 29, 2016

(30) Foreign Application Priority Data
Jul. 31, 2015 (PL) P.413365

(51) Int. Cl. B65G 1/04

(52) U.S. Cl. CPC B65G 1/0485

(57) ABSTRACT

A storage device, especially for storing items such as parcels or courier packages, including a housing 1, shelves 7 with products 5, an automatic inserter/extractor 3, a drop-off/pick-up window 6, and an electronic control panel 8, characterized in that inside the housing 1 three separate zones are located: a low-temperature zone LT, a medium-temperature zone NT, and an ambient-temperature zone PT, separated from each other by insulating panels 2, between which the automatic inserter/extractor 3 moves, whereas the access of the automatic inserter/extractor 3 to the low-temperature zone LT and the medium-temperature zone NT, with temperatures different than the ambient temperature, is obtained through thermally insulating movable partitions 4.

### CROSS-REFERENCE TO RELATED APPLICATION

The priority under 35 USC 119 of Polish Patent Application No. P413365 filed Jul. 31, 2015 is hereby claimed. The disclosure of Polish Patent Application No. P413365 is hereby incorporated herein by reference in its entirety, for all purposes.

### FIELD

The present disclosure relates to devices for storing items, especially items such as parcels or courier packages.

### DESCRIPTION OF THE RELATED ART

In the specifications of the Polish utility model application no. W.121349, a package machine has been disclosed, designed to be installed outdoors, and resistant to adverse atmospheric conditions, such as rain, snow, and sunrays, and having a form of a free-standing device, equipped with a control unit accessed via the Internet, working together with a system of storage boxes designed for sending and receiving packages by customers without any third party involvement. Both the shipping and the package receipt information are generated via the Internet by means of the account of the person logged into the machine owner's system/website. The package machine consists of a storage boxes control module, located inside a frame, which is encased by outer walls, and a wall with storage boxes. The base of the package machine is seated on adjustable feet, and is joined in a detachable way with the frame, covered on both sides by side walls, and at the rear by a bottom screen, middle screen, upper screen, and a central screen. At the front, the package machine is equipped with large storage boxes, medium storage boxes, and small storage boxes, and is covered from above by a roof mounted in a detachable way with bolts sank into sockets.

From the specifications of the American patent application no. US2005063801, a method and an automated system are known, for storing and retrieving varied items or articles, in which the items are stored on shelves, which are grouped into racks. An appropriate retrieval device, controlled by a control unit, travels in front of the racks in such a way, that the retrieval device becomes aligned with the outlet of a conveyor carrying stored articles of a chosen kind, to retrieve at least one article. Items or articles having the same reference codes are stored next to each other on top of one, or a few, freely moving endless conveyor belts, the conveyor belt, or belts, forming the storage surface of the compartments of a magazine rack. The conveyor belts are driven selectively, causing the movement of the articles on the conveyor belts towards the pickup location. The selective drive is achieved by means of drive wheels, mounted to a lift travelling in front of the magazine racks, driving, by means of friction, the conveyor belt or belts containing the chosen or requested article, in such a way that at least one of the first articles on the belt is transported to the receiving surface of the lift.

In the solutions presented above, as well as in the solutions known from the state of the art, the storage devices, or package machines, are equipped with various kinds of manipulators, devices designed for retrieving and delivering automatically stored articles. Also, devices are known, for storing and retrieval of automatically stored products (e.g. pharmaceuticals), in which lowered temperatures are maintained.

In consequence, the art continues to seek improvements in storage devices.

### SUMMARY

The present disclosure relates to devices for storing items, especially items such as parcels or courier packages.

Specifically, the disclosure provides a storage device with a simple design, equipped with an automatic inserter/extractor, intended for storing articles, such as parcels or courier packages, in conditions appropriate for varied types of products.

In one aspect, the disclosure relates to a storage device, especially for storing articles such as parcels or courier packages, consisting of a housing, shelves with products, an automatic inserter/extractor, a drop-off/pick-up window, and an electronic control panel, and characterized in that inside the housing three separate zones are located: a low-temperature zone, a medium-temperature zone, and an ambient-temperature zone, separated from each other by insulating panels, between which the automatic inserter/extractor moves, whereas the access of the automatic inserter/extractor to the low-temperature and medium-temperature zones, with temperatures different than the ambient temperature, is obtained through thermally insulating movable partitions.

In various embodiments, the temperature in the low-temperature zone can be set to any value in the range between −25° C. and −1° C., whereas the temperature in the medium-temperature zone can be set to any value in the range between −1° C. and 25° C.

In various embodiments, the storage device has two drop-off/pick-up windows.

In various aspects, the disclosure relates to a device having three zones in which different temperatures are maintained—a low-temperature zone LT, a medium-temperature zone NT, and an ambient-temperature zone PT, which allow storage—in one device—of products, such as parcels or courier packages, in the zones with temperatures appropriate for the given type of a product (e.g. frozen food, pharmaceuticals, home appliances). An automatic inserter/extractor with three degrees of freedom moves between the zones and the drop-off/pick-up window. The automatic inserter/extractor retrieves an article, which can be a parcel or a courier package, from a respective zone, and places it in the drop-off/pick-up window, or it picks up an article from the drop-off/pick-up window and deposits it in an appropriate zone. The operation of the automatic inserter/extractor is controlled by an electronic control panel.

In various embodiments, the insulation between the zones is achieved through the use of insulating panels, filled with a material with low thermal conductivity, e.g. a polyurethane or polystyrene foam.

In various implementations, the access of the automatic inserter/extractor to the zones with temperatures lower than the ambient temperature is possible due to an application of thermally insulating movable partitions, in the form of hinged, sliding, or roller doors. The thermally insulating movable partitions are thermally insulated, and are controlled electronically or pneumatically.

The higher number of the drop-off/pick-up windows in various embodiments of the storage device allows for simultaneously dropping off and picking up packages in an independent manner.

In the storage device of the present disclosure, as variously embodied, it is possible to store packages with large outer dimensions. It is also possible to mount shelves (e.g. for packages with smaller outer dimensions) in the upper regions of the device, outside of easy human reach—without a need for using additional devices/items, as lifts or ladders.

In the implementation of the storage device of the present disclosure, in various embodiments thereof, the lack of the limitations of the device design in the form of, for example, shelf placement at the level accessible to humans, and also the possibility to store packages of larger outer dimensions, as well as the possibility of placing parts of the device underground or at a specified height, allows for an increase in the device capacity, a greater diversity of goods that can be stored, not only in respect to their storing condition requirements but also in regard to their dimensions, as well as a significant freedom regarding the choice of the placement of the whole storage device.

Other aspects, features and embodiments of the disclosure will be more fully apparent from the ensuing description and appended claims.

### BRIEF DESCRIPTION OF THE DRAWINGS

FIG. 1 shows an illustrative storage device of the present disclosure, in a front view.

FIG. 2 shows the storage device of FIG. 1, along section A-A thereof.

FIG. 3 shows the storage device of FIG. 1, along section B-B thereof.

FIG. 4 shows another example of the implementation of a storage device of the present disclosure, with the zones with different temperatures positioned along the pathway of the automatic inserter/extractor, in a view corresponding to section B-B of FIG. 1.

FIG. 5 shows a further example of the implementation of a storage device of the present disclosure, with a drop-off/pick-up window at one side of the device, in a view corresponding to section B-B of FIG. 1.

FIG. 6 illustrates a shelving configuration of a device according to the present disclosure in a single-row arrangement, in a view corresponding to section B-B of FIG. 1.

FIG. 7 illustrates a shelving configuration of a device according to the present disclosure in a parallel arrangement, in a view corresponding to section B-B of FIG. 1.

FIG. 8 illustrates a shelving configuration of a device according to the present disclosure in an expanded arrangement, in a view corresponding to section B-B of FIG. 1.

FIG. 9 shows a storage device according to another embodiment of the disclosure, with two drop-off/pick-up windows.

### DETAILED DESCRIPTION

The present disclosure relates to devices for storing items, especially items such as parcels or courier packages.

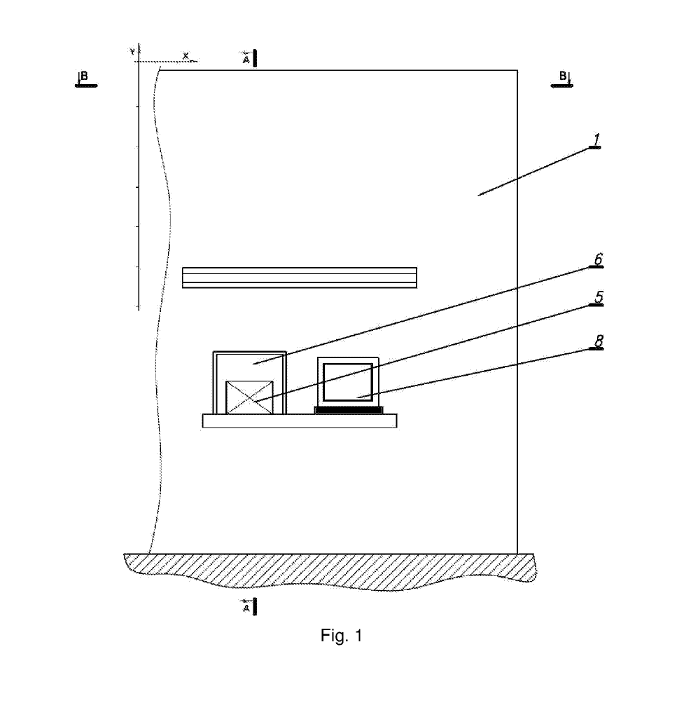

The example of an execution of the storage device, especially for storing items such as parcels and courier packages, shown in FIGS. 1, 2, 3, 4, 5, consists of the housing 1, inside which there are three zones: a low-temperature zone LT, a medium-temperature zone NT, and an ambient temperature zone PT. These zones are separated from each other with the isolating panels 2. The access of the automatic inserter/extractor 3 to the LT and NT zones, with the temperatures differing from the ambient temperature, is being obtained through the thermally insulating movable partitions 4. The automatic inserter/extractor with three degrees of movement, in the X, Y, and Z directions, retrieves a product 5 from the respective zone, LT, NT or PT, from one of the shelves 7 and places it in the drop-off/pick-up window 6, or it picks up the item 5 from the drop-off/pick-up window 6 and deposits it in an appropriate zone LT, NT or PT, on one of the shelves 7. In front of the device, there is the control panel 8 that controls the operation of the automatic inserter/extractor 3.

FIG. 6 shows the shelving configuration of the device according to the disclosure, in an expanded arrangement, where the automatic inserter/extractor 3 travels in front of the shelves 7, along the X-axis.

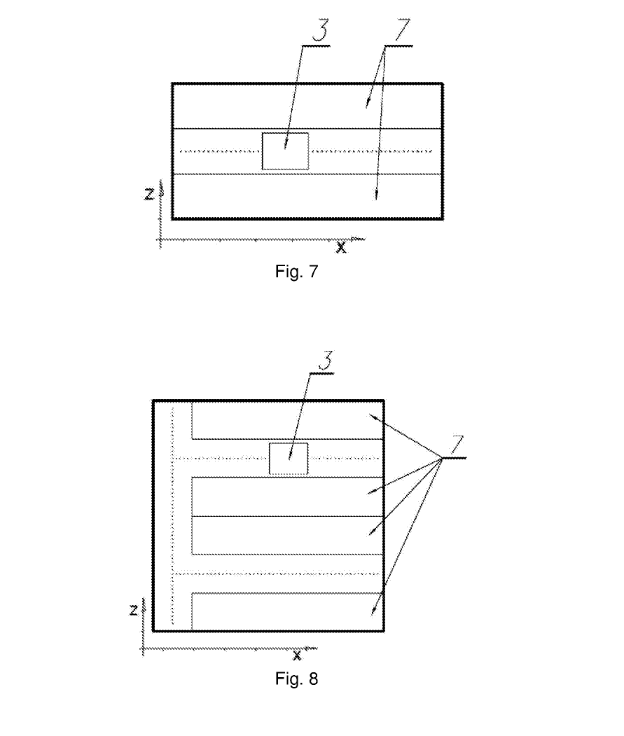

FIG. 7 shows the shelving configuration of the device according to the disclosure, in a parallel arrangement, where the automatic inserter/extractor 3 travels between the shelves 7, along the X-axis.

FIG. 8 shows the shelving configuration of the device according to the disclosure, in a parallel arrangement, where the automatic inserter/extractor 3 travels between the shelves along the X-axis, and in front of the shelves along the Z-axis.

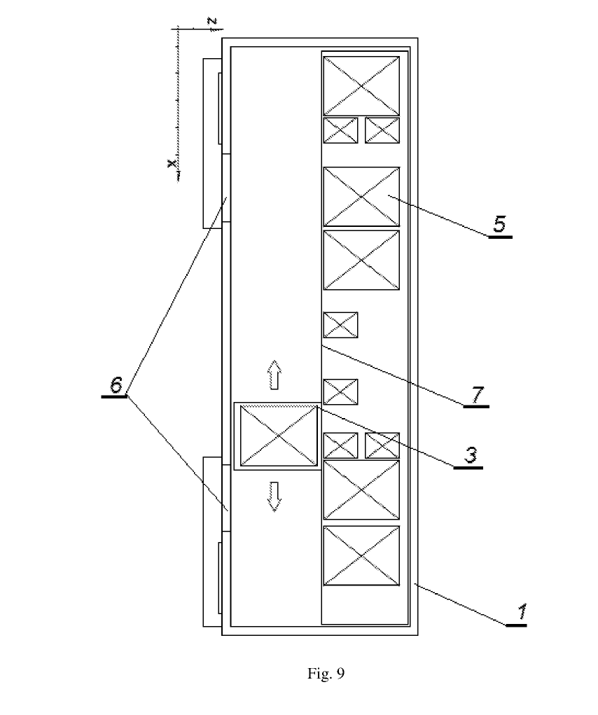

In FIG. 9, a fourth example of the device execution according to the disclosure has been shown, with two drop-off/pick-up windows 6.

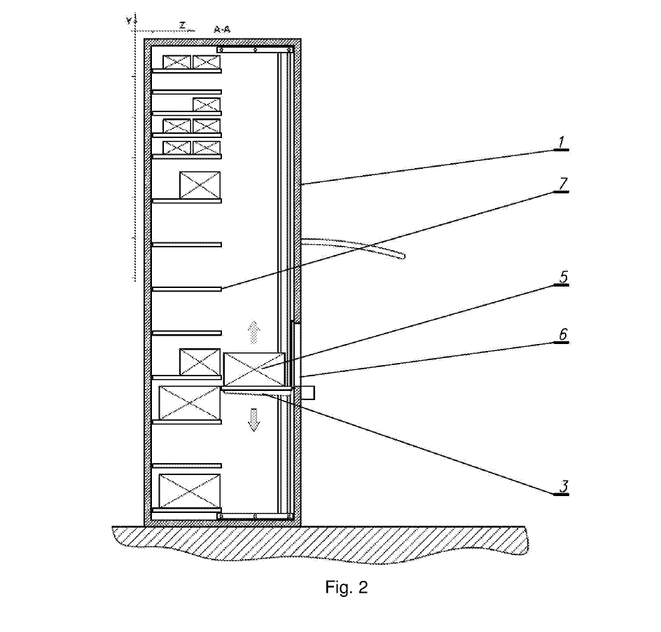

Although in the example of the disclosure execution shown in FIG. 2 the shelves 7 together with the products 5 are located above, below and at the same level as the drop-off/pick-up window 6, alternative solutions are possible, in which the shelves 7 together with the products 5 are located only above, only below, or only at the same level as the drop-off/pick-up window 6.

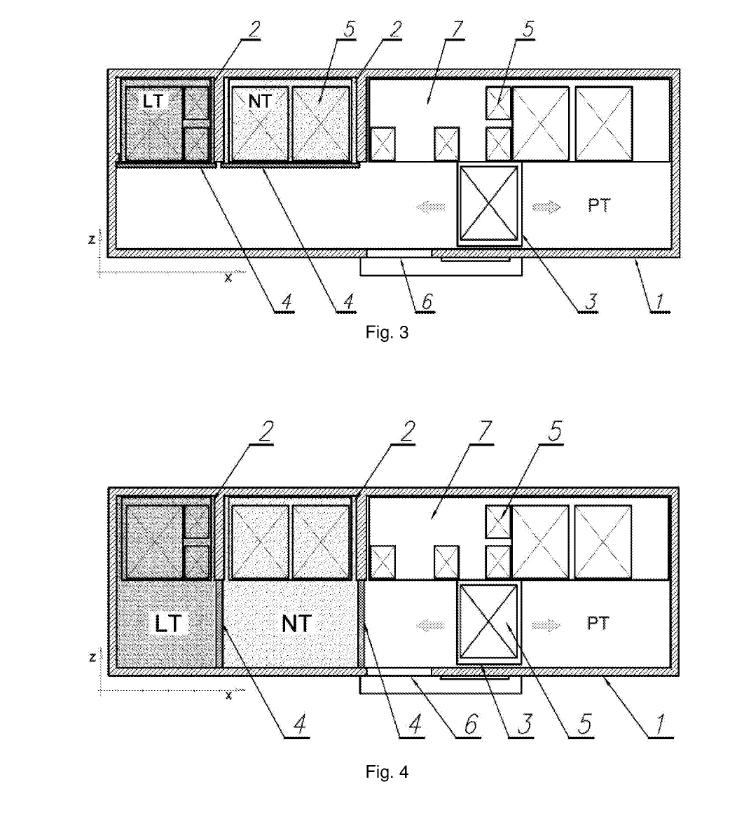

Although in the example of the disclosure execution shown in FIGS. 3 and 4 the zones with differing temperatures are located in the following arrangement (from left to right): the low-temperature zone LT, the medium-temperature zone NT, the ambient-temperature zone PT, other arrangements are possible, with the order of the zones exchanged, e.g., PT, NT, LT, or with only chosen zones present.

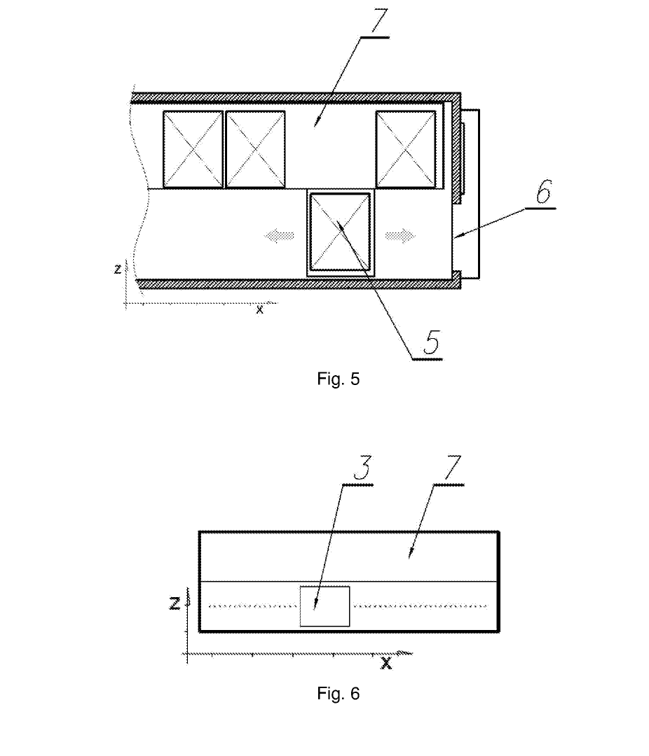

Although in the third example of the device execution according to the disclosure shown in FIG. 5 the drop-off/pick-up window 6 is located on the right-hand side of the device, an alternative execution is possible, in which the drop-off/pick-up window 6 is located on the left-hand side of the device, or the drop-off/pick-up window 6 is located in the middle of the device.

Although in the example of the shelving configuration in an expanded arrangement, shown in FIG. 8, the automatic inserter/extractor 3 travels between the shelves 7 along the Z-axis at the left-hand side of the shelves 7, an alternative solution is possible, in which the automatic inserter/extractor 3 travels between the shelves 7 along the Z-axis at the right-hand side of the shelves 7, or in the middle area between the shelves.

The device operation, according to the present disclosure, is controlled by a programmable system (a computer with appropriate software), which is connected to the end-user's product (goods) distribution system, and which assures the optimal operation of the automation systems.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A storage device, especially for storing articles such as parcels or courier packages, comprising a housing (1), shelves (7) with products (5), an automatic inserter/extractor (3), a drop-off/pick-up window (6), and an electronic control panel (8), wherein inside the housing, three separate zones are located: a low-temperature zone LT, a medium-temperature zone NT, and an ambient-temperature zone PT, separated from each other by insulating panels (2), between which the automatic inserter/extractor (3) moves, whereas the access of the automatic inserter/extractor (3) to the low-temperature zone LT and the medium-temperature zone NT, with temperatures different than the ambient temperature, is obtained through thermally insulating movable partitions (4).

2. The storage device according to claim 1, wherein the temperature in the low-temperature zone LT is in the range between −25° C. and −1° C., whereas the temperature in the medium-temperature zone is in the range between −1° C. and 25° C.

3. The storage device according to claim 1, comprising two drop-off/pick-up windows (6).
